(19) United States
(12) Patent Application Publication
(10) Pub. No.: US 2012/0160410 A1
(43) Pub. Date: Jun. 28, 2012

(54) Water-Based Two-Part Adhesive

(76) Inventors: Juergen Lorenz, Bopfingen (DE); Elisabeth Koenig, Lauchheim (DE); Joerg Kienle, Fremdingen (DE); Rudolf Lauter, Fremdingen (DE)

(21) Appl. No.: 13/404,351

(22) Filed: Feb. 24, 2012

Related U.S. Application Data
(63) Continuation of application No. PCT/EP2010/059745, filed on Jul. 7, 2010.

(30) Foreign Application Priority Data
Aug. 26, 2009 (DE) 10 2009 028 879.1

(51) Int. Cl. C09J 5/02; C08K 5/101

(52) U.S. Cl. 156/307.3; 524/299

(57) ABSTRACT

A method for adhesively bonding two substrates, one substrate being coated with a layer of an aqueous adhesive based on dispersions made of chlorinated polyolefins as well as additives, having a pH from 10 to 13; in a subsequent working step, an activator solution being applied onto the first or second substrate, the activator solution containing substances that comprise acid groups; and adhesively bonding the coated surfaces under light pressure. A two-component adhesive made up of a shelf-stable aqueous adhesive dispersion containing 25 to 50 wt % chlorinated polyolefins, 5 to 30 wt % further polymers, as well as additives and water, at a pH from 9 to 13, and of an activator solution as a second component, the activator solution containing carboxylic acids, sulfonic acids, phosphonic acids, polymers having carboxylic-acid or sulfonic-acid groups, inorganic acid salts, or Lewis acids, as well as water and/or organic solvents.

### CROSS-REFERENCE TO RELATED APPLICATIONS

This application is a continuation of International Patent Application No. PCT/EP20101059745 filed Jul. 7, 2010, which claims priority to German Patent Application No. 10 2009 028 879.1 filed Aug. 26, 2009, the contents of both of which are incorporated herein by reference.

The invention relates to a method for adhesively bonding substrates with a water-based adhesive based on chlorinated polyolefins, at least one substrate having a corresponding adhesive layer, and the adhesive being equipped with an additional activator layer.

Solvent-containing adhesives based on chloroprene are known. In this context, the adhesive is applied as a solution or dispersion, and the solvent can then evaporate. This application mode is time-consuming, and because of the solvent content does not meet present-day environmental protection requirements. Aqueous adhesives as a chloroprene dispersion are likewise known. In this context, various agents are used to adjust or also to lower the pH of the adhesive dispersion.

WO 98/53019 describes aqueous adhesives based on polychloroprene that contain boric acid. In this context, the pH is set to between 7 and 9.5. These adhesives are applied onto the substrates and the latter are then adhesively bonded.

WO 01/77248 describes an aqueous adhesive dispersion that contains a crystalline polyester, a polychloroprene, an acrylate polymer, a further thermoplastic resin, and selected stabilizers. The adhesive is applied onto a substrate, and the substrates are then adhesively bonded.

EP 0 470 928 describes adhesive dispersions that contain chloroprene polymers. These are applied by spray application, two different dispersions being sprayed on simultaneously in order to obtain a good mixture.

FR 2130108 describes contact adhesives based on polychloroprene, an anionic and a cationic latex being applied onto different substrates. Both dispersions, however, contain chlorine-containing polymers.

U.S. Pat. No. 6,087,439 describes aqueous dispersions made of chiorobutadiene polymers that can be used, together with aliphatic isocyanates, as an adhesive. In this context, CO₂ is formed after the isocyanates are mixed in. This results in a modification of the pH, and as a result the binding agent is then precipitated out and simultaneously crosslinked with the isocyanate.

Methods have also already been described for changing the pH of a chloroprene dispersion by adding CO₂, in order to apply it subsequently or simultaneously. Metering of the received and required CO₂, as a function of the constituents of the adhesive, is difficult to control. Such differing quantities, however, result in different properties of the adhesives for the user. These working procedures are overall very complex and susceptible to errors. Also known is a spray method in which an aqueous adhesive dispersion is applied, an acid activator solution being sprayed simultaneously through a second exit opening. Such working procedures require complex spray equipment, however.

From the existing art, the object that arises is that of making available a method in which an aqueous adhesive based on a dispersion of chlorinated polyolefin binding agents can be applied together with further additives, the resulting adhesive layer being shelf-stable over a period of time. Only upon adhesive bonding is this adhesive mixed with an activator and activated.

The object is achieved by a method for adhesively bonding two substrate, one substrate being coated with a layer of an aqueous adhesive based on dispersions made of chlorinated polyolefins as well as additives, having a pH from 10 to 13; in a subsequent working step, an activator solution being applied onto the first or second substrate, the activator solution containing substances that comprise acid groups; and adhesively bonding the coated surfaces under light pressure.

The activator can be present as a layer on the second substrate surface to be adhesively bonded; or the activator is applied, after the adhesive layer, thereonto as a separate layer.

The invention further relates to a two-component adhesive that, as a first component, is made up of an aqueous dispersion of a chlorinated polyolefin having a pH from 10 to 13, and of a second component that encompasses a solution of an activator containing a compound having acid groups.

A two-component adhesive according to the present invention is made up of two components that are stored and applied separately, and are brought together and mixed by the adhesive bonding operation. In this context, one component (as an adhesive component) is intended to be an aqueous dispersion; the second component (as an activator component) is an organic solution or preferably an aqueous solution. The activator solution can be used as a liquid component; it is also possible, however, to produce a solid activator layer from the solution and to use that layer for adhesive bonding.

An adhesive component suitable according to the present invention contains at least one chlorinated polyolefin as a binding agent. These chlorinated polyolefins can be homo- and copolymers of polyethylene, polypropylene, polybutylene, polyisobutene, polyhexene, polyoctene, polydecene and polyoctadecene, polystyrene, and of vinyl chloride. Monomers, such as p-methoxystyrene, acrylonitrile, methacrylonitrile, vinyl acetate, vinyl propionate, vinyl butyrate, vinyl benzoate, vinyl methyl ether, isobutylene, ethylene, vinyl chloride, vinylidene chloride, alkyl acrylates, including methyl, ethyl, propyl, butyl, and octyl acrylates, acrylic acid, and methacrylic acid, as well as other similar monoolefinic copolymerizable compounds such as butadiene-1,3, isoprene, and other butadiene-1,3 derivatives, can also be contained. These polymers can be subjected, as a dissolved or melted product, to chlorination. Another procedure, however, produces suitable polymers by polymerization with chlorinated monomers. Known monomers for this are, for example, vinyl halide, vinylidene halide, chloroprene, styrene, and monoalkenyl aromatic alkyl halides, vinylbenzyl chloride, p-chlorostyrene, 3,5-dichlorostyrene, p-trichloromethyl vinylbenzene, vinylbenzyl chloride-(4-chloromethyl vinylbenzene), or 2,3-dichloro-1,3-butadiene. Chlorosulfonated ethylene polymers or chlorine rubber are also suitable.

Chlorinated polymers having a chlorine content from approx. 20 to 75 wt % are preferably suitable, for example chlorinated polypropylene/polyethylene or polychloroprene at approx. 20 to 50 wt %, or chlorinated polyvinyl chloride having a chlorine content from approx. 60 to 75 wt %. The chlorinated polyolefins can be used in a mixture, but it is also possible to use only one polymer. Polychloroprenes are particularly suitable as binding agents. Chlorinated polyolefins of this kind are commercially obtainable. The quantity of chlorinated polymers is intended to be equal to 20 to 50 wt % based on the entire adhesive dispersion, in particular from 25 to 40 wt %. They are intended in particular to be used as an aqueous dispersion. Such dispersions are present in this context as an alkaline solution; the pH is between 10 and 13.

Further base polymers can also be additionally contained in the adhesives that are suitable according to the present invention. These can be, for example, acrylate copolymers, styrene copolymers, styrene acrylates, or styrene butadienes. Such poly(meth)acrylates are obtainable, for example, by polymerization or copolymerization of ethylenically unsaturated carboxylic acid esters, such as esters of acrylic acid, of methacrylic acid, of crotonic acid, or of maleic acid. Preferably, known C₁ to C₁₂ alkyl esters of (meth)acrylic acid are polymerized. Functionalized monomers can also be contained in this context, for example monomers carrying OH groups or COOH groups. Further copolymerizable monomers can also be contained, for example ethylene, styrene, substituted styrenes. Functionalized or non-functionalized copolymers can thereby be obtained; the copolymers can have a high glass transition temperature (T_{g}) or a low T_{g}. The adhesive behavior at different ambient temperatures can be influenced by way of the additional polymers selected in this manner.

Styrene copolymerizates are another class of polymers. These are copolymerizates of styrene and derivatives thereof. Additional structural units can also be contained, such as butadiene, isoprene, ethylene, propylene, and/or acrylate structures. These further polymers can also be manufactured as a dispersion, and can optionally be stabilized using known surfactants. Acrylate polymers or styrene copolymers of this kind are commercially obtainable as a dispersion, as a solution, or in solvent-free form. The quantity of additional polymers can be equal to between 5 and 35 wt %, based on the adhesive dispersion.

Plasticizers are a further constituent of suitable adhesives. These plasticizers are used by preference to adjust the flow behavior or flexibility of the adhesive layer. Suitable plasticizers are, for example, medicinal white mineral oils, naphthenic mineral oils, polypropylene or polybutylene or polyisoprene oligomers, hydrogenated polyisoprene and/or polybutadiene oligomers, benzoate esters, phthalates, or adipates. Hydrogenated plasticizers, for example paraffinic hydrocarbon oils, or polypropylene glycol, polybutylene glycol, and polymethylene glycol are also suitable; alkyl monoamines and fatty acids can likewise be used. It is preferred to use esters as plasticizers, for example phthalate, benzoate, or adipate esters. The plasticizers are contained in general at a concentration from 0 to 25 wt %, by preference from 2 to 15 wt %.

The adhesive component suitable according to the present invention can furthermore additionally contain as an additive 0.01 to 5 wt %, based on the entire adhesive dispersion, of at least one surface-active substance. These are understood as substances that lower the surface tension with respect to water, such as defoamers, surfactants, wetting agents. As a rule, they contain hydrophilic and hydrophobic, in particular lipophilic groups. The surfactants contained can be anionic, nonionic, or ampholytic, or mixtures of two or more thereof.

Examples of suitable anionic surfactants are alkyl sulfates, alkyl and alkylaryl ether sulfates, such as alkylphenol ether sulfates, fatty alcohol and fatty alcohol ether sulfonates, in particular alkylsulfonates, alkylarylsulfonates, taurides, esters and semiesters of sulfosuccinic acid, which optionally can be ethoxylated, alkali and ammonium salts of carboxylic acids, for example of fatty acids, phosphoric acid partial esters, and alkali and ammonium salts thereof.

Examples of ampholytic surfactants are long-chain-substituted amino acids such as N-alkyl-di(aminoethyl)glycine or N-alkyl-2-aminopropionic acid salts, betaines such as N-(3-acylamidopropyl)-N,N-dimethylammonium salts, or alkylimidazolium beta ines.

Examples of nonionic surfactants are alkylpolyglycol ethers, alkylarylpolyglycol ethers, fatty alcohol polyglycol ethers, fatty alcohol EO/PO adducts and alkylphenol EO/PO adducts, ethylene oxide/propylene oxide (EO/PO) block copolymers, by preference those having approximately 8 to approximately 50 EO resp. PO units, addition products of alkylamines, fatty acids and resin acids, alkylpolyglycosides having linear or branched, saturated or unsaturated alkyl residues with an average of 8 to approximately 24 carbon atoms and an oligoglycoside residue, natural substances and derivatives thereof such as lecithin, lanolin, or sarcosine, polar-group-containing linear organo(poly)siloxanes, in particular those having alkoxy groups with up to 10 carbon atoms and up to approximately 50 EO or PO groups.

Agents for adjusting pH are a constituent of an adhesive component that is suitable according to the present invention. The dispersions of the chlorinated polyolefins are usually stable in an alkaline medium, in which context the pH is intended to be equal to between 10 and 13. This can be ensured by way of the selection and quantity of the neutralizing agents. Bases such as alkali hydroxides or ammonium hydroxide, carbonates, or organic amines can be contained, for example Na₂CO₃, K₂CO₃, NaHCO₃, KHCO₃, Na₃PO₄, Na₂HPO₄, CaCO₃, Ca(OH)₂, NaOH or KOH, DBU, DBN, or borax. It is preferred to use mixtures that establish the pH of more than 10 indicated above. A buffer solution forms, which stabilizes the adhesive system.

Usual adjuvants and additives can furthermore be added to the adhesive component according to the present invention. These can be stabilizers, pigments, or adhesion promoters. They are added usually in quantities of up to 5 wt %, by preference in quantities from approximately 0.1 to 3.0 wt % of the dispersion. The organic solvent content of the dispersion is intended to be low (less than 3 wt %). In particular, no solvents are added and the adhesive is solvent-free; only contaminants from the starting materials are intended to be present. A further embodiment uses adhesive dispersions that contain no substances which react in crosslinking fashion.

The adhesive component according to the present invention is intended to be present in the form of a dispersion. The starting materials, for example a dispersion of the chlorinated polyolefins, in particular of chloroprene, and of the further binding agents, for example of the polyacrylates or styrene copolymers, can already be used in the form of an aqueous dispersion. These dispersions can be mixed; care must be taken in this context that the pH is adjusted so that a stable mixture is obtained, as is the case (as indicated above) in the alkaline pH range. The further additives can be mixed into this and dispersed.

The adhesive component suitable according to the present invention has a viscosity (measured at 25° C., per Brookfield, EN ISO 2555) of approx. 200 to 10,000 mPas; the viscosity is intended in particular to be between 400 and 5000 mPas. The constituents of the dispersion are to be selected so that the total solids are equal to between 40 and 80 wt %, in particular between 45 and 65% (solids determined per DIN 53189, 105° C.). If the viscosity is selected to be lower, improved spray application can be achieved. If the viscosity is selected to be higher, it is easier for the adhesive to form, after application, a stable layer that does not additionally flow and drip off the substrate. A shelf-stable layer of the adhesive can be obtained in this case. If portions of the water evaporate out of the layer, this does not interfere with later adhesive bonding.

The second component of the two-component adhesive according to the present invention is made of a solution of an activating substance. This can refer to organic or aqueous solutions that contain substances having acid groups. Suitable as substances that exhibit acid properties are, for example, solid carboxylic acids or corresponding salts. Examples of carboxylic acids are mono—to tetravalent carboxylic acids having up to 20 carbon atoms, such as formic acid, acetic acid, oxalic acid, maleic acid, fumaric acid, malonic acid, succinic acid, adipic acid, citric acid, tartaric acid, benzoic acid, phthalic acid, isophthalic acid, trimellitic acid, pyromellitic acid, trimesic acid, propane-1,2,3-tricarboxylic acid, fatty acids having 10 to 20 carbon atoms; ascorbic acid or also amino acids are also suitable. Polybasic acids are particularly preferred, preferably solid carboxylic acids. These can be present on the one hand as a solid substance; they can be used as an aqueous solution or dispersion, or they are used together with polymers or oligomers. Another group of acid substances is salts of inorganic acids, which yield an acid pH in aqueous solution. Examples thereof are KHCO₃, NaHCO₃, KHSO₄, NaH₂PO₄, alums such as KAI(SO₄)₂, Al₂(SO₄)₃, and corresponding salts with other alkali metals or alkaline-earth metals. Organic polymers that comprise acid groups can also be used. Examples of such acid groups are phosphonic acid groups, sulfonic acid groups, or carboxyl groups. Poly(meth)acrylic acids, which optionally can also contain other comonomers, are particularly suitable. A further substance class is maleic acid anhydride grafted polymers, which likewise comprise a carboxyl group after hydrolysis. Further examples are carboxymethyl celluloses that contain a high proportion of carboxyl groups.

These substance classes, referred to as an “activator,” are applied as a solution. Aqueous solutions can be used; solutions having organic solvents such as ethyl acetate, methyl ethyl ketone, butyl acetate, but in particular with alcohols such as methanol, ethanol, propanol, butanol, or glycerol, can also be used. The activator substances can also be dissolved or dispersed in plasticizers. Aqueous solutions or dispersions are particularly suitable; these can also optionally contain portions of low-molecular-weight alcohols having up to 6 carbon atoms, in particular ethanol or propanol.

Substances that dissociate in acid fashion can be present in particular as an aqueous solution. Acid polymers can be used as a dispersion in water or as an organic solution. Aqueous solutions that contain only small proportions of organic solvents, or none, are particularly preferred as an activator.

The activator solution can also contain further additives in addition to the solvents. Examples thereof are surfactants, which hold the substances in a stable organic or aqueous solution; these can be substances that influence viscosity, for example ureas. Dyes that make the solution or the applied layer detectable can be used; these can be stabilizers; adhesion promoters such as, for example, silanes having hydrolyzable groups can also be present. The additives should be selected so that they do not negatively impair the acid character of the solution. The activator solution is low in viscosity; usually the viscosity should be equal to less than 2000 mPas; it can also be present in watery form, for example <100 mPas. An activator solution suitable according to the present invention can be applied by means of known methods, but spray application is particularly suitable.

The two adhesive components according to the present invention are mixed as a layer, immediately prior to adhesive bonding or upon bonding. The adhesive yields a stable adhesive bond after a short time.

A further subject of the invention is a two-component adhesive, both components being present in the form of sprayable compositions. The components can be present, for example, as separate disposable pressure containers, for example as aerosol cans, together with propellants. The above-described adhesive dispersions are suitable in this context; aqueous components are to be used in particular. Propellants for producing sprayable compositions are known to one skilled in the art. These can be substances and mixtures that are gaseous at room temperature. For example, gaseous at room temperature can be used, such as C₁ to C₄ alkanes, CO₂, N₂O, dimethyl ether. These are intended to be inert and to be unable to react chemically with the constituents of the components.

A further subject of the invention is a method for adhesively bonding two substrates, in which method a two-component adhesive suitable according to the present invention is used. In this context, a layer of the adhesive component is generated; it is mixed, immediately thereafter or later, with a further layer produced from the activator component; and in that context adhesively bonded.

An embodiment works in such a way that a layer of the aqueous adhesive dispersion according to the present invention is applied onto one substrate. After brief flashing-off, this adhesive layer can be immediately further processed and adhesively bonded, although it is possible to let this adhesive layer stand for a limited period of time. The water content of the adhesive layer can drop in this context, although it is usual for more than 5% moisture to be present in the adhesive layer, in particular from 10 to 30%.

The usual methods for applying the adhesive layer can be utilized, such as spreading, blading, rolling, printing, but it is preferred if a spray application is carried out. In a particular embodiment, the aqueous adhesive component according to the present invention can be present in the form of a spray can together with propellant. It is useful in this context to homogenize the mixture before application and to spray it on immediately thereafter.

As a second component, an activator solution is to be applied and mixed with the adhesive layer. This can occur in a variety of ways.

One embodiment firstly applies the adhesive dispersion necessary according to the present invention. This can optionally be left to stand, provided the layer still exhibits sufficient residual moisture. Immediately before application, the activator layer is applied onto this layer, preferably by spray application. It is preferred in this instance if the activator is an aqueous solution. With this procedure, after application of the activator solution onto the adhesive layer, after a brief time this substrate is adhesively bonded to a second substrate under light pressure. A good adhesive bond forms immediately thereafter. The adhesive bond can occur between two identically coated substrates, but it is also sufficient if only one substrate comprises an activated adhesive layer.

Another embodiment of the invention applies the activator solution onto the second substrate. It is preferred in this embodiment to use an aqueous activator solution. After a short waiting time of, for example, 0.5 to 10 minutes, the second substrate can be adhesively bonded to the first substrate, a moist or aqueous coating still being present. Processing can occur up to the point in time at which a viscous, flowable coating is still present.

For all procedures, it is necessary to ascertain that good mixing of the two layers occurs. This can be assisted by not selecting too thick an adhesive layer. In addition, intermixing of the still-viscous, aqueously moist layers is intended to occur by means of light pressure. Because these are aqueous systems, a rapid change in pH is observable.

A further embodiment applies solvent-containing or aqueous activator solutions onto the second substrate. The solvent or water is then intended to evaporate from the applied coating. A solid, shelf-stable layer of the activator is produced. This layer can be stored for an extended time. It may be useful in this context to cover this layer with a protective film or protective paper. Corresponding polymer layers that comprise acid groups form on the surface, or thin coatings of inorganic or organic compounds that contain acid constituents form.

The second substrate that is used for this embodiment of the method according to the present invention contains, on the side of the substrate to be adhesively bonded, a layer that comprises acid groups. This layer can be a solid coating, for example crystals of solid acids or acid salts; binding agents that comprise acid groups; or polymeric layers that contain acid ingredients. In the case of solid acid-group-containing coatings, the coated substrate is shelf-stable.

In a further embodiment, a storage-capable activator layer on a substrate can be converted before adhesive bonding, by spraying with water or by exposure in an aqueous atmosphere, into a moisture-containing activator layer. Quick intermixing and rapid activity of the adhesive occur as a result of the higher moisture obtained in accordance with this procedure.

In accordance with the method according to the present invention, an adhesive dispersion suitable according to the present invention is applied as a layer onto a substrate. The adhesive is intended to be applied at a layer thickness from 30 g/m² to 600 g/m², in particular from 50 to 200 g/m². The adhesive layer thereby obtained is shelf-stable as long as residual moisture is present in the adhesive layer.

The activator solution is applied onto the second substrate surface to be adhesively bonded, or onto the adhesive layer. The quantity of activator is selected so that the acid groups are sufficient to lower the pH of the adhesive layer. The layer thickness in this context is equal to 10 g/m² to 200 g/m², preferably from 20 to 100 g/m². Low-viscosity solutions can be applied, but it is also possible to apply thixotropic solutions, so that in the case of temporary storage, dripping or flowing of the coated substrate surfaces can be avoided. The generally known application methods already indicated above are possible as application methods.

According to the procedure according to the present invention, the two substrates are adhesively bonded under light pressure. In this, the two coatings are brought into contact and become mixed. Good and rapid intermixing is obtained as a result of the thin layer thickness. The aqueous adhesive layer based on chlorinated polyolefins still contains water. The coating of the activator is likewise still hydrous, or it contains substances forming acid groups in water. When the two coatings are pressed together, intermixing causes the activator to be introduced into the water-containing adhesive layer. This results there in a change in pH, as a result of which adhesive bonding is initiated. A rapid buildup of adhesion in the adhesively bonded substrates is achieved as a result of the rapid intermixing in the completed adhesive layer.

The procedure according to the present invention resp. the adhesive according to the present invention is suitable for series production use and for individual use. For example, the adhesive components can be applied by spray application onto the surfaces to be adhesively bonded. It is possible in this context for the latter to be optionally stored. Immediately before processing, the activator component is applied onto the second substrate and adhesively bonded, or the dried activator layer is adhesively bonded directly to a substrate coated with adhesive dispersion. For utilization at a variety of work sites, preparation of the two-component adhesive according to the present invention in the form of spray cans is useful. Here the solutions are separately produced as an aqueous solution and packaged, together with propellant gases known per se. Immediately before application, the contents of the spray cans are homogenized; spray application of the two components, successively or separately, onto the two substrates to be bonded is then possible.

A plurality of substrates can be bonded. Those substrates that possess a surface that can absorb water or moisture are particularly suitable. These can be, in particular, porous or absorbent substrates.

The method according to the present invention has the advantage that processing of the adhesive dispersion and the adhesive activator can occur separately. It is likewise advantageous that the coated substrates separately exhibit shelf stability, i.e. the time for processing and adhesively bonding the substrates is long.

A further advantage of the procedure according to the present invention is the fact that the adhesive used in the method according to the present invention can be processed in shelf-stable form. Prior activation is not necessary, so that no residues of adhesive that cannot be further used occur. The outlay for cleaning equipment as a result of adhesive residues is furthermore greatly reduced.

### EXAMPLE 1

A mixture is produced from

| | |
|---|---|
| Polychloroprene dispersion (Dispercoll C74 and | 67% |
| C84, 1:6; approx. 55% solids) | |
| Polyacrylate dispersion (Acronal S 400, approx. | 9% |
| 56% solids) | |
| Styrene/butadiene dispersion (Intex 131, approx. | 17.8% |
| 65% solids) | |
| Plasticizer (benzyl ester) | 1.8% |
| Sodium lauryl sulfate (10%) | 2.7% |
| Aging protection agent | 1.3% |
| Buffer solution (made up of glycine, borax, NaOH, | approx. 0.5% |
| ammonium hydrogen carbonate) | |

The constituents are mixed in a high-speed agitation system. The result is a shelf-stable adhesive with a solids content of approx. 55 wt %. The pH is approx. 12. The viscosity of the adhesive is equal to approx. 300 mPas.

An activator solution made up of 10% aqueous citric acid is produced.

Adhering dust is removed from the surface of substrates made of wood and of solid foamed material (5×10 cm). A layer of the adhesive dispersion (approx. 180 g/m²) is applied thereonto.

### Experiment 1

The activator solution is applied onto a substrate based on MDF. The quantity is approx. 30 g/m².

This substrate is adhesively bonded to the substrates equipped with the adhesive layer.

### Experiment 2

The activator solution is applied onto an MDF substrate and dried for 24 hours.

This substrate is adhesively bonded to a further substrate that had been freshly coated with the corresponding adhesive dispersion.

### Experiment 3

A corresponding MDF substrate is processed as in Experiment 2, and dried. Immediately before adhesive bonding, the surface is briefly sprayed with water. Immediately thereafter, the substrate is adhesively bonded to an adhesive-coated substrate.

### Experiment 4

Substrates are coated with a dispersion according to Example 1. After 5 minutes, a layer of activator solution is sprayed onto the surfaces. Adhesive bonding then occurs to an MDF substrate.

The adhesively bonded substrates are pressed against one another. This can also be assisted by brief shifting. The substrates exhibit good mutual adhesive bonding after 15 minutes.

In the Examples, application of the adhesive dispersion and the aqueous activator solution can occur by brushing. Another series of experiment applies both adhesive layer constituents onto the surfaces by spray application.

1. A method for adhesively bonding two substrates, one substrate being coated with a layer of an aqueous adhesive based on dispersions made of chlorinated polyolefins as well as additives, having a pH from 10 to 13; in a subsequent working step, an activator solution being applied onto the first or second substrate, the activator solution containing substances that comprise acid groups; and adhesively bonding the coated surfaces under light pressure.

2. The method according to claim 1, wherein the activator solution contains water and/or organic solvents.

3. The method according to claim 1, wherein the activator solution contains at least one compound selected from carboxylic acids, sulfonic acids, phosphonic acids, polymers having carboxylic-acid or sulfonic-acid groups, inorganic acid salts, or Lewis acids.

4. The method according to claim 1, wherein the adhesive dispersion and/or the activator solution are applied by spraying.

5. The method according to claim 1, wherein an aqueous activator solution is applied onto the first substrate after application of an adhesive layer; or the activator layer is produced on the second substrate.

6. The method according to claim 4, wherein a solid activator layer is produced from the activator solution by evaporation of the solvents.

7. The method according to claim 6, wherein a solid activator layer is moistened with water before adhesive bonding.

8. The method according to claim 1, wherein the activator layer contains mono- or polybasic carboxylic acids, in particular solid carboxylic acids.

9. The method according to claim 1 wherein the quantity of acid groups in the activator layer is sufficient to change the pH of the adhesive layer to pH 6 to 9.

10. A two-component adhesive made up of a shelf-stable aqueous adhesive dispersion containing 25 to 50 wt % chlorinated polyolefins, 5 to 30 wt % further polymers, as well as additives and water, at a pH from 9 to 13, and of an activator solution as a second component, the activator solution containing carboxylic acids, sulfonic acids, phosphonic acids, polymers having carboxylic-acid or sulfonic-acid groups, inorganic acid salts, or Lewis acids, as well as water and/or organic solvents.

11. The two-component adhesive according to claim 10, wherein the adhesive component forms an adhesive layer that becomes mixed with the activator upon adhesive bonding.

12. The two-component adhesive according to claim 10, wherein an adhesive component and/or activator component are used as a dried or completely dried layer.

13. The two-component adhesive according to claim 10, wherein the adhesive component is present together with propellant gas in the form of disposable pressure containers.

14. Use of an adhesive according to claim 10 for adhesive bonding of hard, soft, or flexible substrates, in particular made of films, leather, textiles, wood, metal, hard foam, foamed material, or other polymers.
